(19) United States
(12) Patent Application Publication
(10) Pub. No.: US 2024/0346534 A1
(43) Pub. Date: Oct. 17, 2024

(54) SYSTEM AND METHOD FOR COLLECTING CUSTOMER RESPONSES

(71) Applicant: TRURATING LIMITED, St Ablans Hertfordshire (GB)

(72) Inventors: Theo Isaac MCCABE, London (GB); Alexander MCKAY, Atlanta, GA (US); David Peter Lloyd ALLEN, New South Wales (AU)

(21) Appl. No.: 18/682,726

(22) PCT Filed: Feb. 15, 2022
(86) PCT No.: PCT/EP2022/053667

§ 371 Date: Feb. 9, 2024

(30) Foreign Application Priority Data
Aug. 10, 2021 (GB) 2111499.6

(51) Int. Cl. G06Q 30/0203; G06Q 20/20; G06Q 30/0282

(52) U.S. Cl. CPC G06Q 30/0203; G06Q 20/202; G06Q 30/0282

(57) ABSTRACT

There is provided a system operable to collect, from a customer, a response to a question relating to a transaction, the system comprising: a requesting device configured to send, to a questions server, data relating to the transaction and a request for a question; the questions server, comprising: a processor; one or more databases storing questions; and a rules engine, the questions server configured to: receive the data relating to the transaction and the request for a question from the requesting device; select a question from the stored questions based on the transaction data; and send the selected question to the requesting device; wherein the requesting device is further configured to: present the question to the customer or instruct a display device to present the question to a customer; wherein the system is further configured to: receive a response to the question; and send data related to the response to the questions server or a response database. Corresponding methods, questions server and requesting device are also provided.

### TECHNICAL FIELD

The present invention relates to methods and systems for collecting responses from customers, such as in response to questions relating to goods or services purchased, or regarding other matters. The systems and methods are applicable to in store purchases or online purchases.

### BACKGROUND

It is desirable for businesses to receive feedback from customers, for example to allow it to improve the goods and/or service it offers. The internet enables customers both to provide ratings and also to compare businesses based on the ratings that they have received. For example, online review websites enable customers to provide ratings and feedback on services such as hotel stays, restaurant dining, tradesmen's services such as builders, and quality of goods. The customers generally have to navigate to the review website and provide their review which is usually sometime after the good or service has been purchased.

However, only a very small percentage of customers actually engage in the feedback process, which means that results are never truly representative of the customer base. With review websites, a further problem lies in that the credibility of the reviews provided by customers cannot be validated. For example, some customers may provide inaccurate feedback, whereas other persons providing feedback may not actually have purchased the item being reviewed. Furthermore, conventional methods of feedback require customers to provide personal details such as an email address, but this may discourage some potential reviewers from providing feedback.

In some circumstances, ratings gathered hours or days after an event or transaction are less accurate than ratings gathered during, or immediately, after the time of the sale or purchase. Conversely, in other circumstances, such as for online purchases, it is not possible to provide feedback until a later time because it may take a period of time for the purchased item to be delivered.

There is therefore a need for rating systems which encourage more accurate feedback from a greater number of customers.

There is also a desire to provide a means to obtain feedback from customers or users regarding matters affecting the general population such as social responsibility, health and well-being. It may be desirable to obtain feedback from users across a diverse range of geographical locations without having to send a person or persons to the locations to collect such data. For example, it may be desirable to obtain feedback from users regarding whether they have experienced an earthquake or whether they have experienced symptoms of Covid-19.

WO 2016/071678 A1, by the current applicant, describes a PIN entry device (PED) for electronic Point of Sale (EPOS) transactions. The PED has enhanced user input/output functionality but retains the strict security and certification framework of PED devices. In addition to the usual PED functionality, the PED allows feedback from a user to be obtained in response to a question. FIG. 1 shows a conventional PED 10 of the prior art. The PED comprises an alphanumeric display 12 for displaying text to a user and a keypad having numeric keys 13, keys for Cancel, Clear and Return 14, and in many cases also one or more function keys 15. The PED is configured to operate to display text, such as “Enter PIN” to the user on the alphanumeric display 12 to prompt a response from the user. WO 2016/071678 A1 describes that security is maintained by having the text categorised into two types of text, namely approved text and unapproved text. The PED is configured to accept responses entered on the numeric keypad or one or more function keys in response to approved text, and to accept only a single key press response, often of the numeric keys, when prompted by a display of unapproved text. In this way the PED permits entry of a user's PIN, which is usually made up of 4 or more digits, in response to approved text but does not permit it in response to unapproved text because only a single input is permitted. Accordingly, the use of the one-key response maintains the security of the user's PIN and prevents an unauthorised party from obtaining it fraudulently.

WO 2016/071679 A1, also by the current applicant, describes a system operable to collect customer ratings during a transaction using an electronic Point of Sale (EPOS) system. The system comprises a scanner for scanning bar codes of items to be purchased, a printer for printing receipts of purchases, a display for displaying to a user details such as price of the items purchased, and optionally a cash drawer in which cash received is stored. A PED is also provided for making payments. The system includes a POS module programmed to manage operation of the scanner and PED. A POS proxy module is programmed to cause collection of a customer ratings during the transaction by using information received from the scanner to initiate a customer rating collection session which includes causing the PED to prompt the customer to enter a rating.

WO 2016/071678 A1 and WO 2016/071679 A1 are incorporated by reference herein.

### SUMMARY OF THE INVENTION

The present invention is directed to solving a problem of retailers wanting to ask a focused customer feedback question which takes into account aspects relating to the customer and transaction, such as the time of day, the contents of the customer's shopping basket, the discounts applied, the loyalty of the customer, the type of sale, and/or the payment method. The present invention is provided to address this problem for in-store and online purchases. Prior art methods set questions for the customer which do not take into account the details of the customer and transaction. The questions are set to be generic and address every customer instead of a specific customer or scenario. Hence, a retailer could not directly tailor a survey question to ask about a specific scenario. An example of this could be about the product their customer has just purchased. For example, the retailer is not able to ask a customer their favourite feature of a particular soft-drink they have purchased (Taste, Brand, or Value) if the survey system does not understand if the particular soft-drink is or is not in the customer's basket. It would be a bad experience if the customer had just purchased toilet paper and not the particular soft drink, to receive a question focused on the soft-drink.

The present invention provides a method for determining a single survey question to ask which is contextually aware of the anonymous customer and surrounding transaction details. It is preferable to provide a single question because it takes no longer (one key press) to answer the question than to cancel and not provide a response to the question. Hence, a single question will likely receive higher response rates. Furthermore, by only asking a single question the consumer recognises this and is more inclined to answer because they know they will not be drawn into a lengthy survey. One or more processors analyse a question or survey request data which is combined with or includes context around the details of the transaction, a customer's basket contents, and anonymous data about the customer themselves. In a preferred embodiment this data is used to determine which of series of custom questions qualify. For example, the data relating to the customer or transaction may trigger one or more questions to be asked and these may be given higher priority than any other questions that may be available to be asked. Then one or more processors may make a determination of which specific question to ask based on priority weighting of qualifying questions and core questions using Bayesian probability.

In other embodiments it may be desirable to ask multiple questions depending on the circumstances or scenario. If multiple questions are to be asked in relation to a transaction, to avoid repeating a question, for the steps of asking a second or subsequent question, the already asked question or questions for that transaction should be removed from the selection process. Renormalization of weightings may be required in such a case. If more than one question is to be asked it may be desirable to ask two or three questions.

The present invention provides a system operable to collect a response to a question from a customer during or after a transaction. The system comprises: a requesting device configured to send, to a questions server, data relating to the transaction and a request for a question; the questions server, comprising: a processor; one or more databases storing questions; and a rules engine, the questions server configured to: receive the data relating to the transaction and the request for a question from the requesting device; select a question from the stored questions based on the transaction data; and send the selected question to the requesting device; wherein the requesting device is further configured to: present the question to the customer or instruct a display device to present the question to a customer; wherein the system is further configured to: receive a response to the question; and send data related to the response to the questions server or a response database. The requesting device may be a till or PIN entry device for in-store purchases, or may be a merchant website or merchant website server for online purchases. The system may be applicable to asking a question during or immediately after a transaction. In embodiments the system may be applied after purchases such as for email initiated or app based asking of questions.

In an embodiments, the requesting device may be configured to receive the response to the question, and the response is received as an input from the customer at the requesting device. This may be the case for in-store purchases. In other embodiments, the requesting device may be configured to receive the response to the question, and the response is provided to the requesting device from the display device or another device. This may be the case for in-store embodiments using a separate display or input device to the requesting device; or post-purchase embodiments where the question is directed to the customer by email server but the response is provided to a different entity. In further embodiments, the system may further comprise a response server configured to receive the response to the question and send data related to the response to the questions server or the response database. This may be the case for email initiated post-purchase questions. In embodiments, transaction data may be provided to the questions server from the requesting device and from a second data source.

The system may be configured such that the step of selecting a question from the stored questions comprises randomly selecting a question from the stored questions relevant to the transaction data, such as relevant to a merchant identified in the transaction data.

The system may be configured such that the step of selecting a question from the stored questions comprises: determining, by the rules engine, if any of a first group of questions of the stored questions is triggered based on an element of the transaction data meeting a requirement, and if any one or more of the first group of questions is triggered selecting one of the triggered first group of questions. If more than one of the first group of questions are triggered, selecting one of the triggered first group of questions may be based on a random selection or a weighted random selection. A first group of questions may comprise questions, for example, triggered if the transaction data indicates a particular product was purchased. If there is no trigger for any of the first group of questions, a question from a second group of questions may be asked.

In a preferred embodiment the system comprises: a requesting device, which may be a till or PIN entry device, a merchant website or post-purchase system. The requesting device may be configured to send, to a questions server, data relating to the transaction and a request for a question; the questions server, comprising: a processor; one or more databases storing a first group of questions and a second group of questions; and a rules engine, the questions server configured to: receive the data relating to the transaction and the request for a question from the requesting device; determine, by the rules engine, if any of a first group of questions are applicable to the received data. The questions server configured to select a question from the one or more questions determined from the first group of questions and a second group of questions, wherein the second group of questions are core questions which may be applicable independent of received data, wherein each of the questions in the first group and second group has a weighting, and the selection is based on weighted random selection. The questions server configured to send the selected question to a requesting device.

The question selection by the question server may further comprise generating a third group of questions by adding the questions determined from the first group of questions to the second group of questions. The requesting device may be further configured to: present the question to the customer or instruct a display device to present the question to a customer; receive an input from the customer in response to the question; and send data related to the input to the questions server or a response database.

The question for the customer may be a request to provide a rating, although other questions are also possible as set out in the background section of this application. The rules engine applies rules and triggers relating to when the first group of questions can be added to a group for possible display to a customer. The ratings collected may be provided to the questions server or a response database that stores and collates the data for provision by the customer rating service provider to the client. Along with the question may be sent instructions for the response, such as an indication of which keys or touch pads correspond to positive, negative or neutral response.

The requesting device may be configured to send the data relating to the transaction to the questions server, wherein the data relates to one or more of: the customer; a good or service being purchased; the merchant or vendor; the timing of the transaction; the type of transaction; or the payment type. In more detail the transaction data may comprise one or more of: information relating to each of one or more articles or services purchased, such as product SKU; information relating to the product category of each of one or more articles or services purchased; information relating to the brand of each of one or more articles or services purchased; information relating to the number of characters that can be displayed on a display device on which the question will be displayed; information relating to the presence or absence of a discount; the time of day; the day of the week; information relating to whether a customer is using a loyalty account; the type of payment transaction such as sale, refund, payment, cash, card, voucher]; the type of payment card used such as Visa, Amex, Mastercard; and the amount of the transaction, or any other transaction data to enable a question request.

The question server may be configured to compare the data received from the requesting device with rules from the rules engine to determine if the data matches any triggers set by the rules for applying the first group of questions.

The weightings of the questions from the first group of questions and the second group of questions may be normalized with respect to the combined total weightings of all of the questions from the first group of questions and the second group of questions.

The questions server may comprise a random number generator and the random number generator may generate a random number to select a single question from the questions determined from the first group of questions and the second group of questions based on the normalized weightings of the questions.

The system may further comprise customer input and display apparatus arranged in communication with the requesting device, wherein the requesting device may be configured to send the selected question to the customer input and display apparatus for display, and the customer input and display apparatus may be configured to receive an input from the customer in response to the displayed question and to send data related to the input to the requesting device. In embodiments the question may be sent to the customer input and display apparatus without first being sent to the requesting device.

The customer input and display apparatus may be a PIN entry device (PED) or a Customer Display Unit (CDU). The customer input and display apparatus may be configured to receive as an input in response to the question a single key press. This may be a single key press of the numeric keys or it may be a single key press of other keys such as cancel, clear or of function keys such as F1 to F4. In other embodiments more than one of these keys may be pressed such as two or three presses. The key presses may alternatively be touches of a touch screen.

The requesting device may be a server providing a merchant website and the data relating to a transaction may be based on a basket of goods selected by a customer on the merchant website. The question server configured to instruct a display device to present a question to a customer and receive an input from a customer, may be configured to send the question to the merchant website server for displaying the question on a customer device and receiving input from the customer provided to the merchant website from the customer device.

The system may be configured such that after receiving the response to the question, the requesting device proceeds with the payment transaction.

The question request is sent after a trigger event has occurred. For in-store embodiments the trigger event may be when the POS operator or cashier presses for a total for the transaction and/or selects card payment as the payment type. Alternatively, the question request may be sent after scanning of items in a customer's basket is complete, or after the user has inserted their card into a PED device or has swiped or tapped their card in a contactless payment. Similarly, for other types of payment such as by mobile app/wallet, the question request is sent after the customer has tapped or swiped the payment means. For online transactions the trigger event is after the payment has been approved but prior to an order confirmation screen being presented.

Communications between the requesting device and the questions server may comprise one or more identification (ID) fields. The one or more fields together may provide a globally unique identification or key to a single lane or till of a merchant's store or a particular checkout page of a merchant's website. Accordingly the fields may include identification of one or more of a payment provider, merchant, store/location, and lane or checkout identifier. For example, the ID fields may include one or more of: a Merchant Identification Number (MID), a Terminal Identification Number (TID) and a Partner Identification Number (PID). By providing a globally unique identification, different sets of questions and weightings may be assigned to each shopping lane, checkout or website. Online or website identifiers may take a different form to those for in-store, because for example there is no terminal identifier, instead it is a website or webserver. A partner may be a payment service infrastructure company.

The requesting device may be configured to collect data relating to the transaction prior to sending the request for a question to the questions server.

The collection of data relating to the transaction may comprise collecting information relating to each of the products being purchased prior to sending the request for a question to the questions server (clean), and the sending of data relating to the transaction to the questions server may comprise sending the data as a batch. The collection of transaction data may be completed prior to sending the information, such as to provide what is known as clean data. The data may be sent as a batch after all of the relevant transaction data has been collected. In an alternative embodiment, the data may be sent as each piece of data is collected. If the requesting device sends all of the data together as a batch then it is provided with a memory to store the information. The collection of data as the items are scanned may alternatively take the form of receipt scraping. Sending all the information as one batch send is more efficient in terms of bandwidth of communications to the question server.

In a further alternative embodiment, the transaction data could be sent as each piece of data is collected, such as after each item in the customer's basket is scanned. As the data is received at the questions server, the rules engine may determine if the data includes a trigger. In this way a question could be provided to the user as soon as a trigger occurs which may be very shortly after the item has been scanned. This approach would allow a question to be asked as the items are being scanned.

The data relating to the transaction may comprise information relating to the number of characters that can be displayed on a display device on which the question will be displayed, and the questions server may be configured to remove from the questions available for selection, such as the third group of questions, any questions that have more than the number of characters that can be displayed on the display.

The requesting device may be configured to receive an input from a customer in response to a question, and the requesting device may be configured, if no input is received within a pre-determined time period, to time-out from waiting for a customer input and proceed to request payment authorization.

The weightings of one or more of the questions available for selection, such as for the first group of questions, may be dynamically adjusted after each instance of receiving an input in response to said one or more questions, for example to meet a target such as the number of times the question is asked in a period.

The system may be configured to perform a two-legged exchange of communications between the requesting device and the questions server. The first leg of the communications may comprise the steps of: sending, by the requesting device to a questions server, data relating to the transaction and the request for a question, and sending, by the questions server to the requesting device, the selected question. The second leg of the communications may comprise the steps of: sending, by the requesting device to the questions server, data relating to the input from the customer in response to the question and optionally sending data relating to a payment of the transaction. Optionally, the questions server may be configured to send to the requesting device an acknowledgement of receipt of the data relating to the input from the customer in response to the questions and data relating to a payment of the transaction.

The present invention provides a method of collecting a response to a question (such as collecting a rating) from a customer during or after a transaction, the method comprising: sending, by a requesting device (such as a till, PIN entry device, merchant web server, or user consumer device such as a tablet or phone), to a questions server, data relating to the transaction and a request for a question; receiving, at the questions server, the data and the request for a question; selecting, by the questions server, a question from stored questions based on the transaction data; and sending the selected question to the requesting device, wherein the requesting device: presents the question to the customer or instructs a display device to present the question to a customer; and wherein the system receives a response to the question; and sends data related to the response to the questions server or a response database for collation of responses.

The step of selecting may comprise: determining, by the questions server, if any of a first group of questions stored at the questions server are applicable to the received data; generating, by the questions server, a third group of questions by adding the questions determined from the first group of questions to a second group of questions, the second group of questions being core questions applicable independent of the received data, wherein each of the questions has a weighting. A question is selected from the third group of questions by a weighted random selection.

Communications between the requesting device and the questions server may comprise a synchronous call, that is, where the connection or channel is kept open until the communication steps are complete. Synchronous calls are used for communications to a financial institution during authorization of a payment. Here we are using a synchronous call to provide dynamic content to the requesting device.

The method may comprise a two-legged exchange of communications between the requesting device and the questions server. The first leg of the communications may comprise the steps of: sending, by the requesting device to a questions server, data relating to the transaction and a request for a question, and sending, by the questions server to the requesting device, the selected question. The second leg of the communications may comprise the steps of: sending, by the requesting device to the questions server, data relating to the input from the customer in response to the question and optionally, data relating to a payment of the transaction. Optionally, the questions server may send to the requesting device an acknowledgement of receipt of the data relating to the input from the customer in response to the questions and data relating to a payment of the transaction.

The second leg of the communications may take place after the payment transaction has been authorized. The first leg of the communications may take place before sending a request for payment authorization. The communications may be over HTTPS in an XML/JSON format in real-time sent over the Internet. API communications may be by gRPC.

The requesting device may send the data relating to the transaction to the questions server and the data may relate to one or more of: the customer; a good or service being purchased; the merchant or vendor; the timing of the transaction; the type of transaction; or the payment type. In more detail the transaction data may comprise one or more of: information relating to each of one or more articles or services purchased, such as a SKU code; information relating to the product category of each of one or more articles or services purchased; information relating to the brand of each of one or more articles or services purchased; information relating to the number of characters that can be displayed on a display device on which the question will be displayed; information relating to the presence or absence of a discount; the time of day; the day of the week; information relating to whether a customer is using a loyalty account; the type of payment transaction, for example, sale, refund, payment, cash, card, voucher; the type of payment card used such as Visa, Amex or Mastercard; and the amount of the transaction, or any other transaction data to enable a question request.

The questions server may compare the data received from the requesting device with rules from the rules engine to determine if the data matches any triggers set by the rules for applying the first group of questions.

The method may further comprise normalizing the weightings of the questions determined from the first group of questions and the second group of questions (or forming the third group of questions) with respect to the combined total weightings of the questions determined from the first group of questions and the second group of questions (or from all of the questions of the third group).

The questions server may comprise a random number generator and the random number generator may generate a random number to select a single question from the questions determined from the first group of questions and the second group of questions (or the third group of questions) based on the normalized weightings of the questions.

The requesting device may be a server providing a merchant website and the data relating to a transaction may be based on a basket of goods selected by a customer on the merchant website.

The method may comprise, after receiving the response to the question, the requesting device proceeds with the payment transaction. The communications between the requesting device and the questions server may comprise a unique global identifier as set out previously, such as one or more of: a Merchant Identification Number (MID), a Terminal Identification Number (TID) and a Partner Identification Number (PID).

The requesting device may collect data relating to the transaction prior to sending the request for a question to the questions server. The collection of data relating to the transaction may comprise collecting information relating to each of the products being purchased prior to sending the request for a question to the questions server, and the sending of data relating to the transaction to the questions server comprises sending the data as a batch.

The data relating the transaction may comprise information relating to the number of characters that can be displayed on a display device on which the question will be displayed, and the questions server may remove from the questions available for selection (such as the third group of questions) any questions that have more than the number of characters that can be displayed on the display.

The requesting device may wait to receive an input from a customer in response to a question, and if no input is received within a pre-determined time period, the requesting device may time-out from waiting for the customer input and proceeds to request payment authorization.

The method may further comprising dynamically adjusting the weightings of one or more of the questions available for selection after each instance of receiving an input in response to said one or more questions, such as to meet a target number of times the question is asked in a time interval.

The present invention further provides a requesting device, comprising a processor and a communications interface, the requesting device configured to: send, to a questions server, data relating to a transaction and a request for a question; receive, from the questions server, a selected question; present the question to the customer or instruct a display device to present the question to a customer; receive an input from the customer in response to the question; send data related to the input to the questions server (or response database for collation of responses); and send a request for authorization of a payment to a financial institution.

The present invention provides a questions server, the questions server comprising a processor, a communications interface, a database storing a first group of questions and a second group of questions, and a rules engine, the questions server configured to: receive, from a requesting device, data relating to a transaction and a request for a question; select a question from the stored questions based on the transaction data; and send the selected question to the requesting device.

The question server may be configured to select a question by; determining, by the rules engine, if any of a first group of questions are applicable to the received data; generating a third group of questions by adding the questions determined from the first group of questions to a second group of questions, the second group of questions being core questions applicable independent of the received data, wherein each of the questions has a weighting. A question is selected from the third group of questions by a weighted random selection.

The questions server may be further configured to: receive data related to the input from the customer; and send, to the requesting device, an acknowledgement of receipt of the data relating to the input from the customer.

The present invention may further provide a system operable to collect a response to a question from a customer during a transaction, the system comprising: a merchant website server configured to send, to a questions server, data relating to the transaction and a request for a question; the questions server, comprising: a processor; one or more databases storing a first group of questions and a second group of questions; and a rules engine, the questions server configured to: receive the data relating to the transaction and the request for a question from the merchant website server; determine, by the rules engine, if any of a first group of questions are applicable to the received data; selecting a question from the one or more determined questions from the first group of questions and a second group of questions, wherein the second group of questions are core questions applicable independent of the received data, wherein each of the questions has a weighting, and selecting question is based on a weighted random selection; and send the selected question to the merchant website server; wherein the merchant website server is further configured to: instruct a customer device to present the question to a customer; receive from the customer device an input from the customer in response to the question; and send data related to the input to the questions server or a response database.

### BRIEF DESCRIPTION OF THE DRAWINGS

Embodiments of the present invention, along with aspects of the prior art, will now be described with reference to the accompanying drawings, of which:

FIG. 1 is a schematic diagram of a PIN entry device (PED) of the prior art;

FIGS. 2A-2C are block diagrams showing elements of three embodiments of a system for providing questions and collecting responses from a user or customer;

FIG. 3 is a flow-chart showing the steps of a method of providing a question and collecting a response from a customer;

FIGS. 4A-4C are flow-charts showing steps of three embodiments of a method for selecting a question based on transaction information;

FIG. 5 is a flow-chart showing additional detail of the steps of FIG. 4A according to an embodiment of the present invention;

FIG. 6 is a schematic diagram showing elements of a system for providing questions and collecting responses from a user or customer;

FIG. 7 is a schematic diagram showing additional detail of FIG. 6 for an in-store transaction embodiment;

FIG. 8 is a schematic diagram showing additional detail of FIG. 6 for an online transaction embodiment;

FIG. 9 is a schematic diagram showing additional detail of FIG. 6 for a post-purchase email initiated survey collection embodiment;

FIG. 10 is a schematic diagram showing additional detail of FIG. 6 for an app based survey collection embodiment;

FIG. 11 is a diagram showing an exchange of communications between a requesting device and a questions server according to an embodiment of the invention; and

FIG. 12 is a UML diagram showing a sequence of events and messages for providing a question to a customer and receiving a response from the customer.

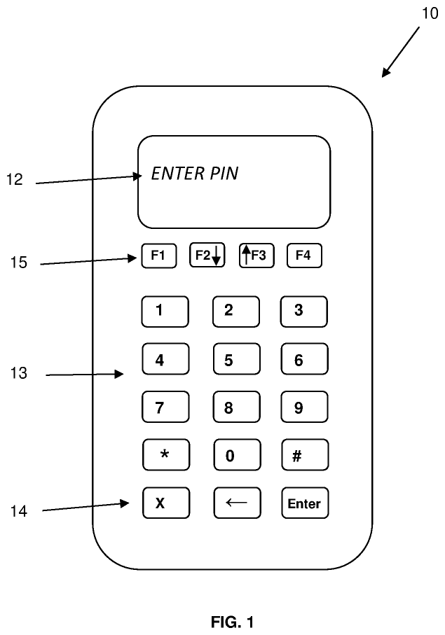

### DETAILED DESCRIPTION

The present invention seeks to build on the PIN entry device and payment systems of the prior art by dynamically and intelligently determining a question to be displayed to a customer based on data from a requesting device. The data may be an indication of items in the customer's basket which he or she is purchasing. Although the PIN entry devices of the prior art are used for in-store purchases, the present invention is also applied to purchases made online that do not use PIN entry devices. Furthermore, other data and scenarios are also envisaged. For example, after purchase (also known as post-purchase) scenarios are considered that use similar techniques via email and apps.

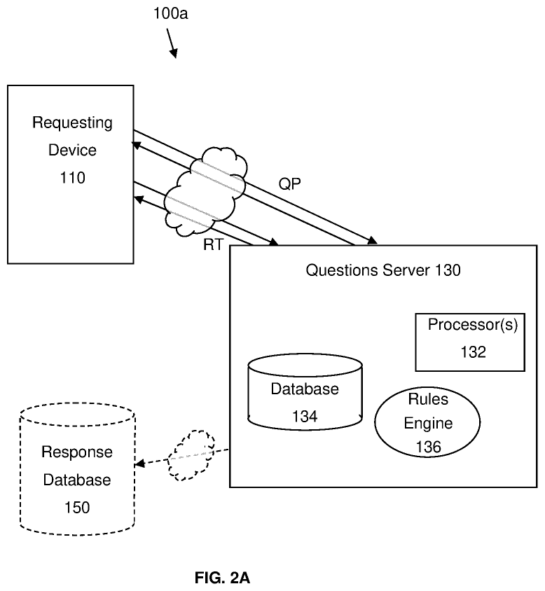

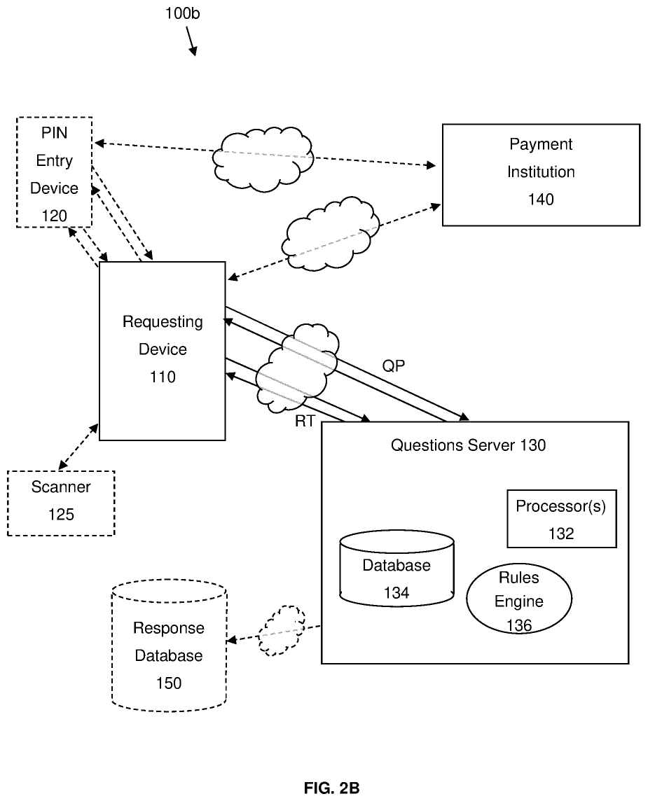

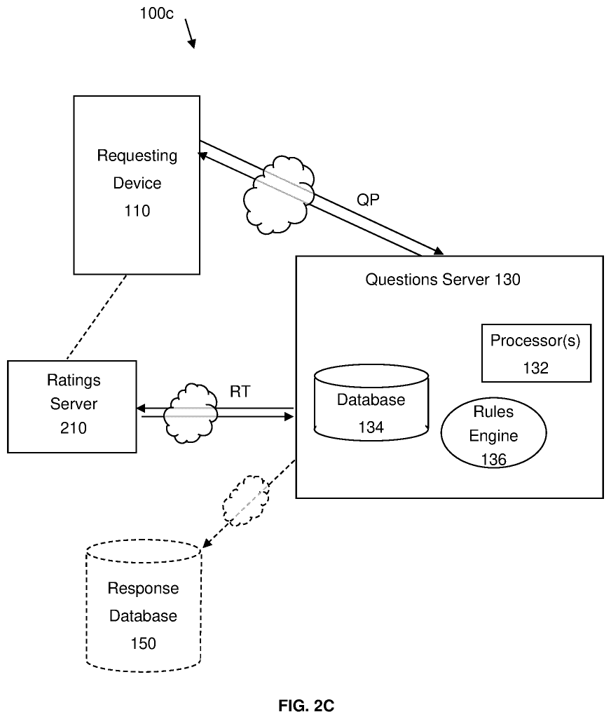

FIGS. 2A to 2C illustrate three configurations according to the present invention. FIG. 2A is a schematic diagram of a system 100a for collecting responses from a customer or user according to a first embodiment. The system comprises a requesting device 110 and a questions server 130. The requesting device 110 may be a till or cash register, a PIN entry device, a PIN-on-glass device, a touch screen device such as a customer display unit (CDU), or other device. The requesting device may alternatively be a server providing a merchant's website or a server providing data for an app such as an application for financial services. The questions server 130 is remotely located to the requesting device 110. For example, the questions server 130 may be located at a data centre or at an office of the applicant. The questions server may be considered to be located in the cloud. Multiple questions servers may be located at various different locations across countries and around the world. The requesting device 110 is configured to communicate with the question server over the internet by means of secure communications. In FIG. 2A parts of the internet are represented by clouds. The questions server 130 comprises a database of questions 134, one or more processors 132 and a rules engine 136. The rules engine 136 analyses data received from the requesting device to determine a question to be provided to the requesting device.

FIG. 2A also shows a response database 150 which is a database where responses to questions provided from customers may be stored for further analysis. The response database may be located remotely from the questions server, as shown in FIG. 2A, or may be located at the same location as the question server. When located at the same location as the question server, the response database 150 may be combined with the database 134 to provide a single database storing both questions and responses. Alternatively, the response database may be located at premises of the applicant such that the applicant can perform analysis of collected responses or the response database may be located at premises of a client or user for whom the responses are being collected. In general the response database will be accessible over the internet.

The operation of the system shown in FIG. 2A will now be described. Following a transaction, the requesting device 110 is provided with data relating to the transaction. The data may be information related to the item or items purchased, although many other types of data are also possible as we will describe below. The requesting device 110 sends a request for a question to the questions server 130 along with the data relating to the transaction. The questions server receives the request for the question and the transaction data and selects a question based on the transaction data. We will discuss below various options for how the question selection is performed. After selecting a question the question is sent to the requesting device 110. The requesting device receives the question and the question is displayed to the customer or user. The requesting device may display the question itself or may pass the question on to another device, such as a display device or a customer's device such as tablet or laptop. The user responds to the question. The response may be provided by the user to the device displaying the question or to another device. The response is sent to or returned to the questions server or may be sent directly to a response database.

In a first method of selecting a question the question server selects a question from the database of questions based on the transaction data. The transaction data may include information identifying the merchant and the question may be selected randomly from a group of questions relevant to the merchant. The selection from the group of questions may be a random selection. In other words, each time a question is requested, a question from the group for that merchant is selected at random. It is believed that this implementation will be the first cloud-based randomised provision of questions relating to purchases.

The transaction data may include information relating to different aspects of the transaction. For example, the transaction data may identify a product or service purchased by the customer.

In a second method of selecting a question the questions server may check the transaction data to see if a particular product or service has been purchased. If the particular product is identified as having been purchased then the question server selects or triggers a question related to that purchase. If multiple questions are selected based on multiple particular products being identified as having been purchased the question server may select one of them. The selection may be at random, based on a weighted random selection or may be based on other factors.

In a third method of selecting a question from the database of questions the question server may determine from the transaction data that a particular product has been purchased but the question server may also have a set of questions that are normally asked for the merchant. In such a case the question server selects between a custom question related to the purchase and a set of core questions that are normally asked for the merchant. The selection between the questions may be at random or based on a weighted random selection or may take other forms. Other information in the transaction data may also be used to select the question. In general there will be the following different types of information in the transaction data:
Default or minimum data which may specify the merchant such that the question server knows to use questions relevant to that merchant;
Temporal data such as specifying the time of day, day of the week, month or year of the purchase;
Basket data related to the items being purchased;
Anonymous customer data such as may be derivable from information entered during an online purchase or from a loyalty card, but not identifying the customer; and
Payment data such as the type of payment, amount of payment and whether a discount was received.

The default or minimum data may always or usually be required as questions are almost always tailored to the merchant to some degree because each merchant will have different products or services for sale, or may have different objectives for the aspect of their service they wish to receive feedback. Nevertheless, it is possible that the question may be selected from a set of generic questions that are commonly applicable.

FIG. 2B is a schematic diagram of system 100b for collecting responses from a customer or user according to an embodiment of the invention. The system is similar to that of FIG. 2A but additional devices are shown. FIG. 2B is directed to the example of in-store purchases. Similarly to FIG. 2A, the system comprises a requesting device 110 which may be, for example, a till or cash register or other device for submitting orders or collating items being purchased and prepared for payment. A PIN entry device 120 may be connected to the requesting device for a user to make payments such as by credit or debit card or loyalty card. In some embodiments a PIN entry device is not provided separately and the functionality is included at the requesting device 110. The requesting device or PIN entry device comprises a display and a keypad or touch screen for receiving inputs from a customer. The display may be known as a Customer Display Unit (CDU) and may be provided, for example, as a tablet style device separate to the requesting device or as part of the requesting device. In a further alternative, a PIN on glass device may be used. In other embodiments chip and signature may be used. The requesting device, PIN entry device, PIN on glass device or CDU is configured to receive inputs from a user. For a PIN-on-glass device or CDU the display screen may display a virtual PIN entry device and be responsive to touch gestures. The CDU may be a large POS-connected touch screen or other customer facing screen.

Similarly to FIG. 2A, FIG. 2B includes a questions server 130 and again the requesting device is configured to communicate with the question server over the internet by means of secure communications. A requesting device closer geographically to a questions server will have reduced latency in receiving questions. This is particularly relevant for in-store transactions and has advantages in avoiding delays at tills in waiting for questions to be received over large distances. It is preferable if the question is provided to the requesting device within 250 ms, or more preferably within a tenth of a second, of the request for a question being sent. The time for a question to be provided is usually dominated by the latency across the internet. It takes less than 50 ms for the question server to select the question but the time for communications across the internet may be up to 100 ms or more. As for FIG. 2A, the questions server 130 comprises a database of questions 134, one or more processors 132 and a rules engine 136.

Optionally, the system 100 may include a scanner 125 connected to the requesting device for scanning codes such as barcodes of products or services being purchased. In some embodiments the scanner is integrated into the requesting device whereas in other embodiments it is provided as a separate device in communication with the requesting device. Although we have described the requesting deice as, for example, a till, it may alternatively be a kiosk, self-checkout, or a mobile Point-of-sale. For in-store transactions a scanner is a convenient way of adding an item to be purchased, and its price, to the basket or list of items. However, for online purchase there is clearly no need for a scanner. Moreover, in-store environments also do not require a scanner and other means of adding items to a transaction are available.

FIG. 2B also shows response database 150 as for FIG. 2A. FIG. 2B additionally shows a payment institution 140 which may be bank or credit/debit card provider. The payment institution authorizes payments. In FIG. 2B the PIN entry device is shown as configured to communicate with the payment institution, such as securely over the internet, to receive authorization of payments for goods or services. The communications between the payment institution and PIN entry device take the form of the many conventional communications that occur such as during card payment processes. If the PIN entry device is not provided then the payment institution will communicate with whichever device is collecting the payment information.

Although we have described FIG. 2B in relation to an in-store scenario with optional PIN entry device and optional scanner, the embodiment is also relevant to online purchases without the PIN entry device and scanner. The merchant's website server may be considered to be the requesting device. The customer browses a merchant website on their device in the usual manner selecting the items they wish to purchase and adding them to their virtual basket. On checkout the merchant website directs the customer's browser to connect to the financial institution and the customer inputs their payment details such as credit or debit card information. The payment institution checks the payment details and, if correct, sends an authorization to the merchant website. The merchant website server wishes to provide a question to a user so is configured to send a question request to the questions server 130 along with transaction data. The questions server selects a question based on the transaction data and sends the question to the merchant website server. The merchant website server can then provide the question to the customer's browser at the same time as providing confirmation or approval of the transaction. The customer's response to the question is provided back to the questions server or to a response database in the same manner as described above.

FIG. 2C is the third alternative scenario for collecting responses to questions from a customer. FIG. 2C is directed to a post-purchase configuration for receiving feedback. The purchase may be an online or in-store purchase but the customer is sent an email relating to the purchase from, or on behalf of, the merchant. The requesting device in this arrangement may be the provider of the afore-mentioned email to the customer, which may be the merchant or a third-party. When it is determined that an email is to be sent to a customer regarding a purchase the email provider sends transaction data to the questions server and requests a question. The questions server selects the question and sends it to the email provider. The email provider includes the question in the email to the customer. The user opens the email containing the question and clicks on a response to the question. A difference here may be that the response is not necessarily returned directly to the requesting device 110 but may be sent to a ratings server 210, for example, provided by the applicant. The ratings server may be separate to the questions server 130 and response database 150 or may be the same device.

A further alternative post-purchase arrangement is to include a link in a financial application. In such an arrangement the requesting device may be a user's device such as a tablet, phone or laptop, which may include a financial services application installed thereon. The financial services application may, for example, be a banking application. The financial services application would be aware a transaction with a merchant because it is notified of the transaction and provided transaction data by the merchant. The application requests a question from the question server and presents the customer with an opportunity to provide a rating regarding the transaction. The arrangement here is similar to that set out in FIG. 2A. If the user responds the response may be sent back to the questions server and on to a response database or may be sent directly to a response database,

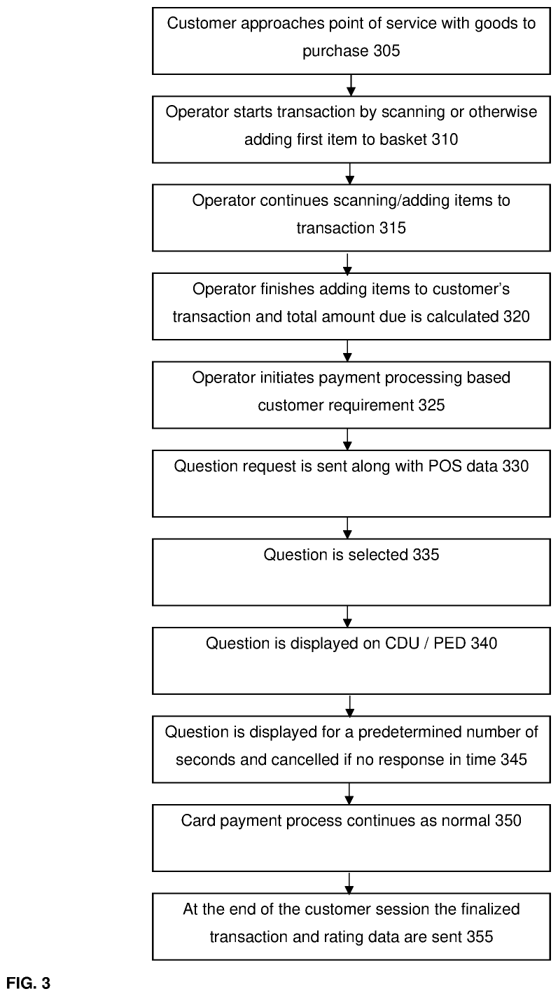

FIG. 3 is a flow chart setting out steps of a payment and question transacting process. At step 305 a customer arrives at a point of service or point of sale, such as a till or payment point, with one or more goods to purchase. The one or more goods to purchase may be known as a basket of goods. A customer display unit or CDU may be in idle mode and may be displaying information from the merchant or advertisements scrolling on a loop. At step 310 the operator at the point of service starts a transaction by scanning a first of the goods the customer wishes to purchase. The operator may alternatively add the good to the transaction in other ways. For example, by manually entering a code representing the goods or selecting the goods from a list or selection. At step 315, if there are further goods the customer wishes to purchase, the operator continues by scanning or otherwise adding the goods to the transaction. The goods added to the transaction are sometimes known as a basket of goods. At step 320 the operator adds the last of the goods the customer wishes to purchase to the transaction and a total amount due for payment is calculated. The total may be calculated by the requesting device or other tilling device connected to the requesting device. At step 325 the operator initiates processing of payment for the goods based on whether the customer wishes to pay by card, voucher, cash or other means. Here the initiation of payment by the operator triggers the requesting device to request a question, but other triggers are possible and will be described in the following paragraphs. The requesting device, at step 330, sends data relating to the transaction to the question server along with a request for the question server to provide a question for display to the customer. At step 335 the question server determines, based on the data received relating to the transaction, the question to be displayed to the customer and sends the selected question to the requesting device. Details of the steps in determining the question to be displayed will be described in the next paragraphs. At step 340 the selected question is displayed to the customer, such as on the CDU or on a PIN entry device (PED). The question will invite the user to respond using the numeric keys on the PED or virtual numeric keys on the CDU. Preferably, the full range of single digit numeric responses 0-9 will be available to the customer. If the customer provides a response the requesting device returns an acknowledgement on the CDU or PED such as “Thanks for Rating”. If the customer does not wish to provide a rating he or she may, for example, press “skip” or “cancel” or wait for the question to time-out. As shown at step 345, the question will be displayed for a predetermined amount of time after which the question will no longer be displayed. If no rating is provided by either the customer pressing “skip” or “cancel” or by waiting for the question to time-out, the CDU or PED may display a different acknowledgement that no rating has been provided, such as “Sorry you didn't rate”. At step 350 the payment process continues as normal by the user being asked to enter their PIN or tap their card on the PED or requesting device. A request for approval of the payment is sent to the financial institution. If the payment is approved the PED or requesting device displays an acknowledgement of payment in the conventional way. Similarly, if payment is not approved then an appropriate message is displayed. After the payment transaction, at step 355, details of the finalised transaction and response to the question are sent to the questions server or alternatively to a different server collecting responses. The CDU returns to the idle state which may be displaying merchant information or an advertising loop.

In the above description of the flow chart of FIG. 3 we describe that step 340 the customer being asked the question and following this at step 350 the user is asked to enter their PIN or tap their card. Other options include mobile payments such as by bringing a mobile phone close to the payment device. The timing of asking the question may also be varied. For payments in which the card is inserted the question may be asked during the dead time between entering a PIN and receiving approval of the payment back from the bank or financial institution. For contactless payments, by card or phone, the question may be presented to the customer after tapping but before receiving approval of the payment from the bank or financial institution. As an alternative the question may be asked earlier. For example, for a PED or CDU displaying a scrolling receipt of items, for example as the items are scanned or entered by the operator, the question may be asked after all of the items have been scanned or entered but before the customer confirms the amount to pay. Following this the payment process proceeds and after approval of the payment an acknowledgement of providing a rating may be displayed.

The trigger for requesting a question has been discussed as when the operator initiates the payment process. This may be, for example, by pressing “Total” or by pressing “Card payment” or other type of payment. Alternatively, the request for a question may be triggered when a payment card is inserted into the payment device or when the card or mobile device initiates a contactless payment. In each of these alternatives after the step of triggering, a request for a question (along with transaction data) is sent to the questions server and the returned question is then displayed to the customer. For online transactions the triggering of the question will be different because a card is not usually physically presented to the requesting device. We will discuss triggers for online payments in the following.

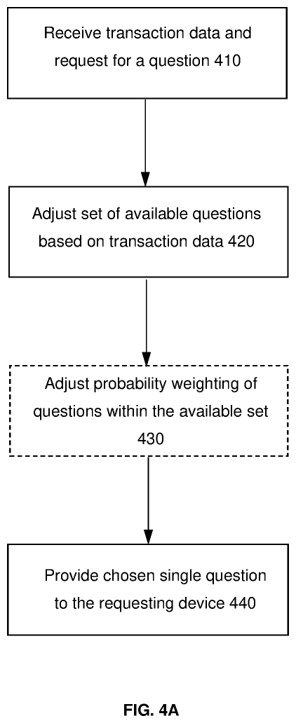

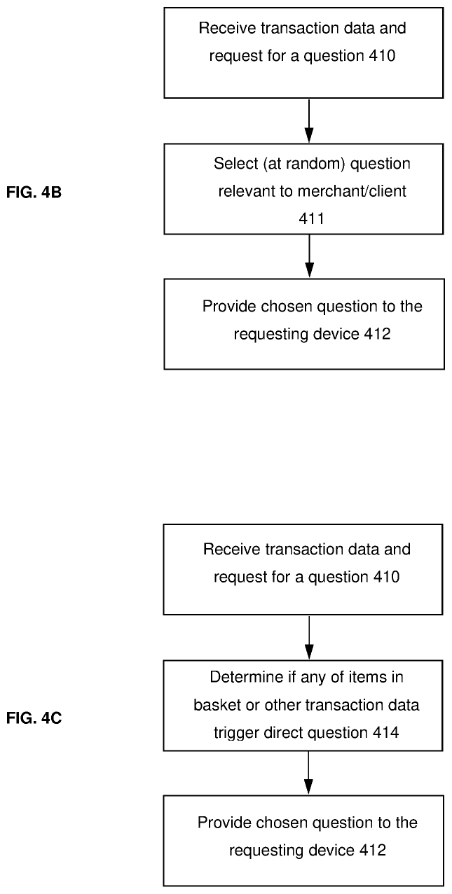

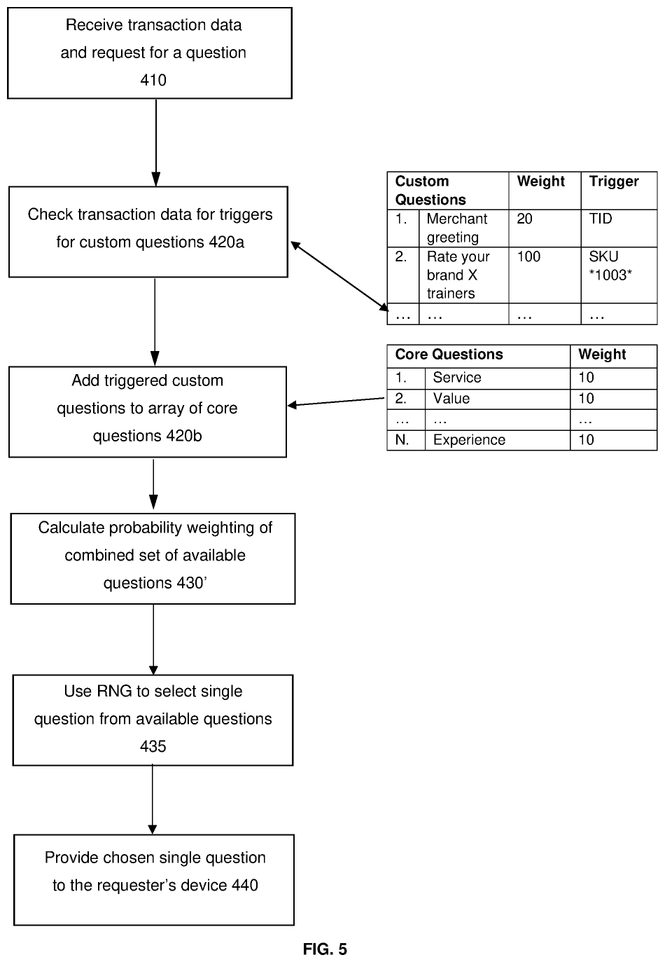

FIGS. 4A-C and FIG. 5 provide more detail on the step 335 of selecting a question. The process of selecting a question takes place at the question server. FIG. 4A describes a first embodiment regarding how the question is selected, with additional detail provided in FIG. 5. FIGS. 4B and 4C describes alternative embodiments for selecting question.

As shown in FIG. 4 at step 410, the request for a question is received at the question server along with transaction data. The transaction data may include information on the goods in the basket, the time of day or other information. We will discuss later in the description the types of information and how they are used. At step 420 the set of available questions is adjusted based on the transaction data. Having adjusted the questions that are available, the weighting of the questions may need to be adjusted to compensate for questions added or removed or for other reasons. For example, it may be required to increase weightings if a question is removed, for example by normalizing the weightings. A question from the available set is then selected at random, but taking into account the weightings, and at step 440 is provided to the requesting device. FIG. 5 is a more detailed flow-chart of example steps in the question selection process performed by the question server. The process again starts with the transaction data and request for a question being received from the requesting device at step 410. This is also indicated in FIG. 2 by the lines representing communications between the requesting device and questions server, which are labelled QP (which stands for requesting a Question and sending POS Transaction data). At step 420a in FIG. 5 the questions server checks the transaction data for the presence of data for triggering custom questions. An example, would be where the transaction data includes information on the items the customer is purchasing such as a product SKU (Stock-keeping unit). In the table of custom questions in FIG. 5 the second custom question is triggered if the customer purchases a product having SKU *1003*. In the example, this SKU code identifies a particular type or brand of trainers. The presence of the SKU code in the transaction data triggers a question relating to the trainers to be added to the set of questions from which a single question will be asked. The question relating to the trainers may, for example, be “Rate your brand X trainers”. The transaction data may include many other types of information on which a custom question may be triggered, such as time of day. Multiple custom questions may be triggered depending on the transaction data. Another example of a custom question is to ask whether you were greeted by the merchant. This question could be triggered based on the Terminal Identification Number (TID), namely the identification number of the till, requesting device or payment processing device. The process of determining and selecting questions in this way may be known as dynamic or intelligent questions.

Transaction data, which may include basket data and customer data, is not conventionally provided to a requesting device or PED, to do so here the requesting device or PED may be provided with a pass-through server which allows the data to be obtained from the till.

At step 420b the triggered custom question or questions are added to a set of core questions. The core questions are questions that are always in the set of possible questions that may be selected to be presented to the customer and they are independent of the content of the transaction data received. In the example table in FIG. 5, the questions are identified as relating to service, value and customer experience, although there are other possibilities for core questions. The table of core questions indicates “Service”, “Value” and “Experience”. The corresponding questions may be “Rate the service you received”, “Rate the value of your purchases” etc.

At step 430′ in FIG. 5 the weighting of the questions is adjusted. This adjustment may be to normalise the weighting of the questions. If the total weighting of all of the questions is not 100%, then it is desirable to normalise them to total 100% to make question selection easier. For example, if there are seven core questions each having a weight of 10 and a custom question is triggered having a weight of 100, then the total weight is 170. In this example, the weights of the core questions are normalised to 5.88% and the custom question would be normalised to 58.82%.

Custom questions may have greater weights than core questions because they are asked less frequently. This is because they will only be added to the set of questions to be considered if the transaction data includes the respective trigger for the question. Hence, the weighting may be greater than for core questions to make them increasingly likely to be asked when triggered. Accordingly, custom questions may be considered to be given priority over the core questions.

In some embodiments the question weighting may be adjusted based on other factors such as relating to requirements of the client or to increase the frequency of, or make more uniform the frequency of, asking custom questions. We will discuss this more in later paragraphs of the description.

After the weightings have been adjusted a single question is selected at step 435 from the set of possible questions. The selection is performed using a random number generator (RNG), which in combination with the weightings provides a weighted random selection of the question. For example, the weights of all the questions would add up to 100% with intervals corresponding to different questions. Using the example numbers in the preceding paragraphs the interval 0-5.88% might correspond to the first core question; the interval 5.89 to 11.76% might correspond to the second core question and so on. The selected question is then sent, at step 440, by the question server to the requesting device. In an alternative arrangement the text of the questions could be stored at the requesting device and the questions server performs the selecting step. However, this approach has disadvantages in that the questions stored at the requesting device will need to be updated regularly as new questions campaigns occur and also requires storage at the requesting device to store the questions as well as logic for triggering dynamic questions. By storing the questions at the questions server the questions can be updated easily and it is not bandwidth intensive to send a text string representing the question to the requesting device.

We have discussed example options of the data that may be included in the transaction data that is sent from the requesting device and is used to trigger custom questions. For example, earlier we mentioned that the information relating to the transaction might fall into one of the following categories: default or minimum data; temporal data; basket data; anonymous customer data; and payment data. For online purchases, and email or app driven ratings collection there is also the possibility the transaction data may be online/email/app based data. In more detail, the transaction data may include additional data regarding the items in the basket, or regarding the basket as a whole, such as:
Product SKU;
Discount;
Product Category;
Brand name;
Time of Day;
Day of the Week;
Whether the customer uses a loyalty account;
Type of transaction (for example, sale/refund/payment etc.);
Type of payment (cash, card, voucher etc.)
Type of payment card (Visa, Amex, Mastercard etc.);
Amount of the transaction;
UTM data; and
Hash of phone number relating to customer.
   Additional or different data may also be included. Accordingly, based on the preceding examples, custom questions may trigger based on:
An analysis of the contents of the customer's basket and whether a product having a specific SKU is present or absent;
An analysis of the contents of the customer's basket and whether a specific discount has been applied or not;
An analysis of the contents of the customer's basket and whether any product in a particular product category is present or absent;
An analysis of the contents of the customer's basket and whether any product having a specific brand name is present or absent;
An analysis of the transaction data's detail and a determination of the time of day;
An analysis of the transaction data's detail and a determination of the day of the week;
An analysis of the transaction data's detail and a determination of whether the customer uses a loyalty account;
An analysis of the transaction data's detail and a determination of the type of transaction (sale/refund/payment etc.);
An analysis of the transaction data's detail and a determination of the type of payment card used; and
An analysis of the transaction data's detail and a determination of the amount of the transaction.

It was mentioned above that the question weighting may be adjusted based on other factors such as relating to requirements of the client or to increase the frequency of, or make more uniform the frequency of, asking custom questions. In an embodiment of the present invention, the question weighting may be dynamically adjusted. This may be for example, because a client wants to ensure that a dynamic question is asked a certain number of times within a time period. Conventionally, to provide a question a certain number of times an administrator of the questions campaign would need to manually set and adjust the weighting of the questions so that the frequency of asking the questions is as required. This might result in a high weighting to ensure the relevant question is asked very frequently to gather a number of responses early on and then after a while having checked that enough responses had been gathered the administrator would modify the weighting so that the question is asked less frequently. However, by having the question asked frequently and then infrequently causes problems and could skew the data. For example, if the question is asked ten times in the morning and only once in the afternoon it does not allow for the performance of reliable analytics over both morning and afternoon.

In the embodiment of the present invention a Dynamic Prioritization engine is provided to modify the weighting (frequency) of the dynamic question within the client's question set using analytics of estimated throughput (number of transactions in a time period) against the occurrence of the dynamic scenario (for example, how often the product is purchased) and calculate a weighting (frequency) the question should be asked. The Dynamic Prioritization engine will re-evaluate the weighting (frequency) at which the question is asked each time a response is gathered. This allows the number of times a question is asked to be dynamically adjusted to meet certain targets such as:
Ask the question at each store in a certain time period;
Ask the question no more than a number of times a day;
Ask the question only a certain number of times; and
Ensure the question gets asked at least a certain number of times in a time period.

The Dynamic Prioritization engine is provided at the questions server along with the rules engine 136. To avoid delaying the provision of questions to a requesting device the adjustment or updating of weightings may be performed immediately after the question has been selected and sent to the requesting device, such that any update is ready for the next time the question is added to the set of questions for selection. While this approach may work for data collected on a store by store or local basis, it is common to have such requirements set globally and then the updating of weightings would likely have to occur asynchronously. Global data may not be available in real-time so the updating of weightings would occur asynchronously alongside real-time in-store sessions. The updating of weighting could be triggered once per day at a certain time or when triggered by a certain event. This would allow the weighting of questions to be updated across all stores for a particular merchant so meet global requirements.

FIGS. 4B and 4C relate to alternative implementations of question selection, which we will now describe. FIG. 4B commences with the step of receiving transaction data and request for a question at step 410. As for FIG. 4B the request may be received at the question server. The question server then selects a question at step 411. The question selected may be selected at random based on the available questions such as the available questions for that merchant or client. In the embodiment of FIG. 4A the selection may not take into account items in the basket. Once selected the question is sent to the requesting device at step 412.

The process of question selection shown in FIG. 4C also commences at step 410 with receiving the transaction data and question request. At step 414 the questions server checks the transaction data to determine if the data triggers any questions directly based on the transaction data. This may be similar to the custom questions discussed above. However, in the case of FIG. 4C the triggered question is not added to core question for a weighted random selection but is instead selected as the question to be asked. Similarly to FIG. 5 an example might be that a particular product having a particular SKU code is in the basket of items and the presence of this SKU code triggers a questions related to the product. Many other types of trigger based on the contents of the transaction data are possible, such as those discussed above. The presence of the triggering data causes the related question to be asked. If the transaction data includes more than one trigger then the questions server selects which of the triggered questions to ask based on a priority, random selection or weighted random selection. Once the question is selected the question is sent to the requesting device at step 412.

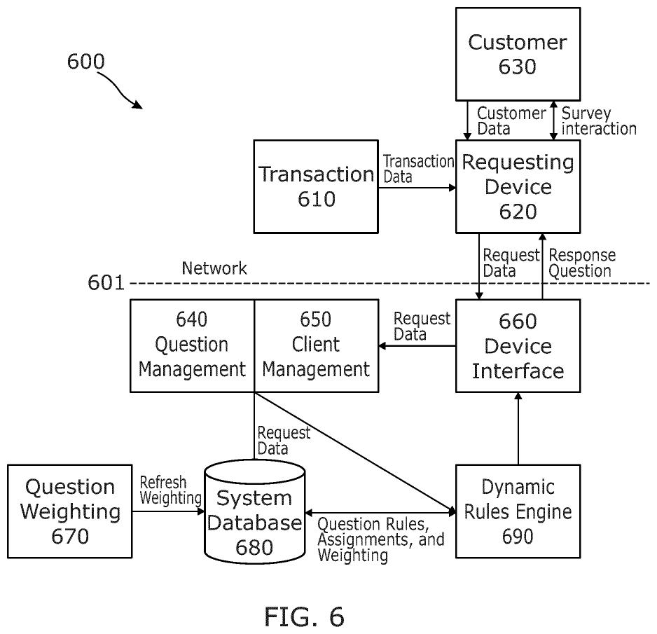

FIG. 6 is schematic system diagram similar to FIGS. 2A and 2B but with additional network features shown. The system 600 includes in-store or merchant side components and network side components. Above the line 601 labelled “Network” in the figure the components are store-side or merchant side, whereas below the line they are network components located in the cloud or at the premises of the applicant or a mixture of the two. Some of the network components may be located at multiple locations around the world to provide functionality local to the merchants. Requesting device 620 may correspond to requesting device 110 in FIG. 2A. The requesting device 620 receives or generates transaction information 610. The transaction information may be received from a tilling device or may be generated by the requesting device itself. The requesting device may also receive customer data from customer 630. This data may be anonymous data and indicate aspects such as the transaction type, a language selected or triggered by the customer and/or whether they have a loyalty card. Actual details of the customer, such as name and card number, will not be sent to maintain the collection of data anonymous. The requesting device 620 sends the transaction data and request for a question securely across the Internet to device interface 660. The transaction data and request data are transferred to client management 650 and question management 640. Client management 650 analyses the transaction data to check matters relating to the client, which may be the merchant or store owner. For example, the client management 650 may determine which surveys the client is undertaking and which one or ones are applicable to the transaction. For example, the transaction information may include a Merchant Identification Number (MID), a Terminal Identification Number (TID) and a Partner Identification Number (PID). The partner is the entity that has integrated the methods described herein into any of the in-store, online, email or app implementations. For example, for an in-store POS implementation the partner may be the POS or PED device manufacturer, whereas for online the partner may be the online merchant or provider of the online merchant's website. The PID may be unique to the implementation.

A particular survey may only be applicable to a selection of stores of the merchant or only to a selection of terminals. The question management 640 may be used to configure the questions to be asked based on the client's requirements. For example, questions may be updated or added to the set of questions for a particular client using the question management 640.

The anonymity of a customer, as discussed above, is maintained because no personally identifiable information (PII) is collected, that is, no information is collected that could link directly to a person using the data. Of course, ratings are collected in combination with transaction information. In some cases where a better relation between ratings and customers is desired a one-way hash is made of the some element of the customer information, such as their last name or the last four numbers of their payment card. This hash makes a token which cannot be reversed to obtain the identity of the customer. The token can be tagged with the data to allow correlations between the ratings and anonymised customers to be followed, such as for repeat transactions.

System database 680 stores questions for all clients, or all clients for the specific geographic region to which the database is being used. Rules for applying questions for each client, and each survey campaign for each client are also stored in the system database. Question weightings are stored at the system database 680 but question weighting interface 670 may be used to refresh weightings or adjust then dynamically if required.

Transaction data is sent from the client and question management 640 and 650 to the dynamic rules engine 690. The dynamic rules engine 690 is a computer program that selects a question, for example, based on the methods of FIGS. 4A-4C and 5. Here we describe the dynamic rules engine as selecting a question based on the method of FIGS. 4A and 5. Dynamic rules engine 690 checks the transaction data for triggers for applying custom questions. The dynamic rules engine 690 is similar to rules engine 136 of FIG. 2A. The dynamic rules engine, having identified any custom questions based on triggers in the transaction data, combines the custom questions with core questions to create a set of available questions. Each client may also have a different array or set of core questions. The weightings of the questions are adjusted or normalized and a single question is selected, as described in relation to FIG. 5. The text of the selected question is sent to the device interface 660 which sends the question to the requesting device for display to the customer. The customer 630 answers the question. After the transaction has completed the answer or rating and transaction information is returned by the requesting device to the device interface 660 for storage and/or collation of results.

By keeping the processing logic of selecting a question remote from the requesting device and in-store devices, the in-store devices can be kept more general and have less processing and memory requirements.

Although FIG. 6 has been described in relation to an in-store scenario, it can also be applied to online purchases. In such a case the components below the network line 601 would continue to be located in the cloud or at the premises of the applicant or a mixture of the two. Components above the network line 601 would be at a combination of on a client's server or on a customer's device. For example, a customer making purchases on a website on his computer or tablet would be connected to the client's website. The requesting device would be the servers of the client's website and the step of displaying the question would comprise sending the question to the customer's device. The customer would have the same options for payment as in-store, except for cash, and so the transmitting of transaction data and selection and supply of the single questions would occur in the same manner.

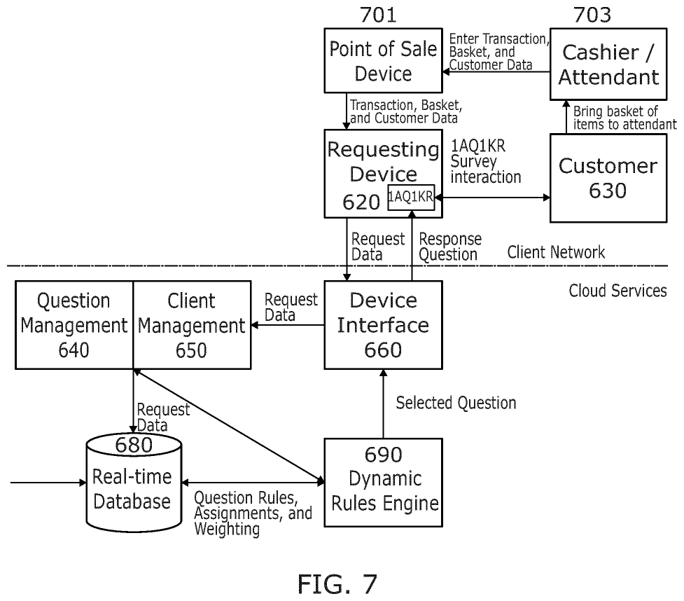

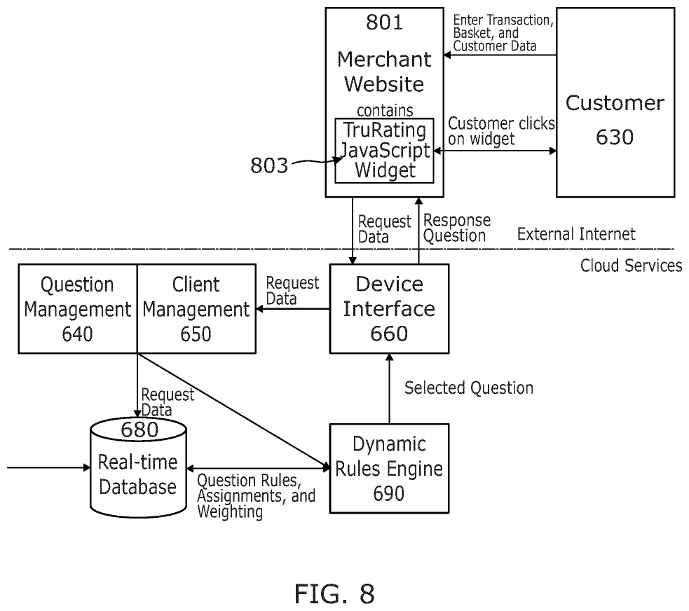

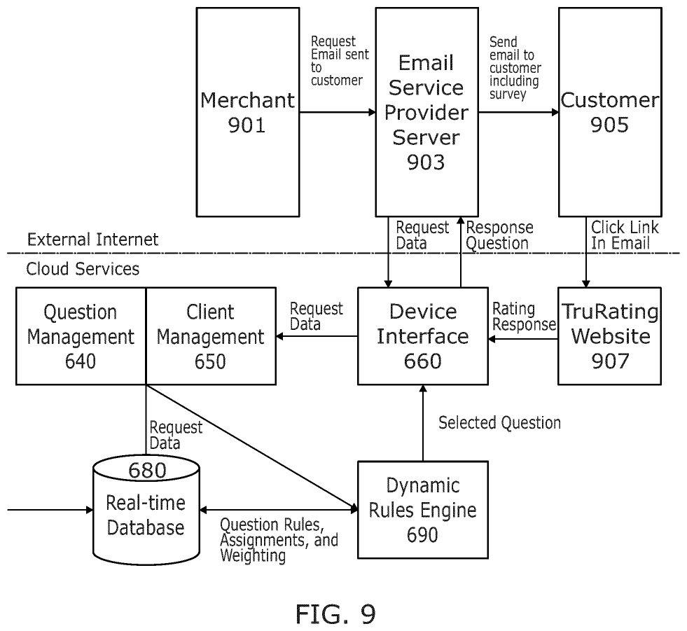

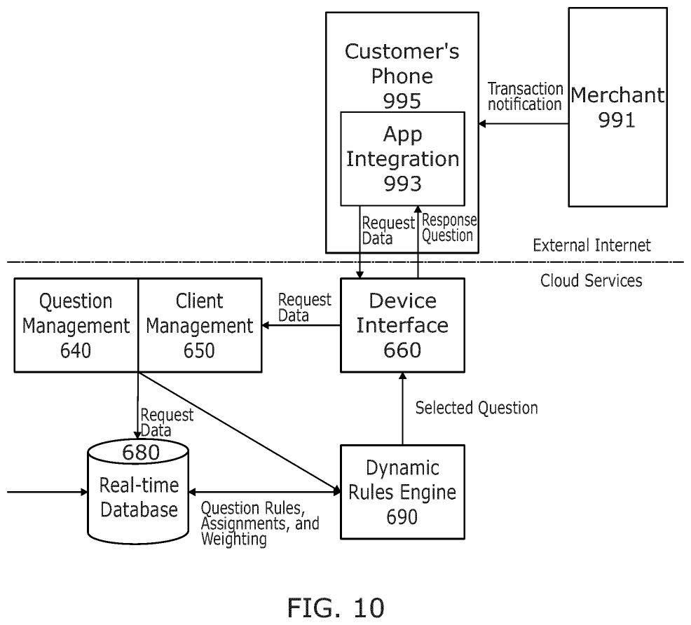

FIGS. 7 and 8 are modified versions of FIG. 6 respectively for an in-store scenario and an online purchasing scenario. FIGS. 9 and 10 are further modified versions on FIG. 6 respectively for the post-purchase scenarios of email and app based ratings. Like reference numbers are used in FIGS. 7-10 for features that are not substantially changed from FIG. 6.

As shown in FIG. 7, the system additionally includes a point-of-sale device 701 (POS device). This may be a till with a PIN entry device connected to it. Customer 630 approaches the cashier/attendant 703 with their actual physical basket of products they wish to purchase. The cashier or attendant opens a transaction and adds or scans the items to a virtual basket at the point-of-sale device 701. The point-of-sale device transmits the transaction information including information on the basket of goods and customer information to the requesting device. The requesting device 620 may be the till itself or may be a separate device. The requesting device sends the request for a question and the transaction data to the device interface in the manner described in relation to FIG. 6 and receives a single selected question back in return. The question is displayed on a PIN entry device which is either connected to the Point-of-sale device 701 or the requesting device 620. The customer may provide their response in the manner described above.

In FIG. 8, which relates to online purchases, the client network has been replaced by the external internet. The merchant website is provided by servers and is running on a customer's device, as discussed above. The merchant's website 801 includes a JavaScript widget 803 which adds the functionality of the present disclosure to the merchant's website. In FIG. 8 the customer is shopping online on the merchant's website. After he or she has chosen all of the goods he or she wishes to purchase, he or she enters payment details and confirmation of the virtual shopping basket of goods are sent to the merchant website. If payment is by credit or debit card, the payment information is sent to the financial institution for authorization. Data relating to the transaction, such as time/day may also be sent to the merchant website. Customer data such as whether a loyalty card has been used may also be sent to the merchant website.

The merchant website includes the widget. The widget receives the transaction information and sends a request for a question and also sends transaction information to the device interface 660. The question management 640, client management 650, database 680 and dynamic rules engine 690 perform their functions as described earlier, namely to determine if triggers are present in the transaction data to trigger custom questions. Then having selected a single question from the core question and any triggered custom questions, the question is provided by the dynamic rules engine to the device interface 660 which sends the question to the merchant website. The widget of the merchant website causes the merchant website to display the question to the customer 630. This is displayed after the payment process has largely completed. Preferably, the user enters their payment details, such as card number, expiry date, CVV code etc. and sends the payment information. The financial institution checks the payment details and sends authorization. The merchant website may indicate a confirmation of the order along with authorization of payment. The merchant website displays the question to the user on this confirmation page. For online purchases it is preferable not to interrupt the sale and payment process so the customer is surveyed on the confirmation page. Accordingly, the trigger point for requesting a question may be considered to be the receipt of the confirmation or conversion of the order. Online purchases may be paid for by gift card, loyalty card, Paypal etc., and similar considerations for the timing of the question apply. For online asking of questions again a single question may be asked and the response may be provided a by single key press or a single touch on touch screen device.

After the customer has entered their response to the question the response is sent from the customer's device to the widget at the merchant website and returned to either the questions server or a response collation database, as described above in relation to the PIN entry device. An acknowledgement may be returned from the questions server or collation database to the widget, and the merchant's website then causes the acknowledgement to be displayed to the user on his or her device.

FIG. 9 is a figure similar to FIGS. 7 and 8 but for post-purchase surveying by sending an email to the customer after the sale. The customer may purchase goods or services online or in-store. Following this the merchant 901 may request a ratings email is sent to the customer. For in-store purchases the customer will have provided an email address to the merchant such as for sending a receipt for the purchase to the customer. The merchant 901 may trigger the email as being sent based on a time or event, such as the goods being delivered, an item having been picked up from the store, or a number of days since the purchase. The merchant provides an email ratings service provider 903 with the request that a question is asked and request data containing the transaction data which may include information such as anonymised customer data and basket data. The email ratings service provider's server sends a request and the transaction data to the device interface 660. The email ratings server provider may alternatively be provided by a widget in the merchant's website or email provider. The various components as discussed above determine a dynamic or intelligent question to be asked and this is returned to the email ratings service provider server 903 which sends a question to the customer with the question in the email. When the customer clicks on the question, or a rating in response to the question, in the email it opens the question/response in the customer's web browser on their device. The web browser takes the customer to the applicant's website 907. The website shows the customer which value/response they clicked on. The website may also provide other options such as to modify their rating as well as to leave additional qualitative context in an optional text box. The information from the customer's browser is sent to the applicant's website or server 907 which provides the rating back to the device interface 660.

FIG. 10 is a schematic diagram describing how an app based post-purchase implementation may operate. The app or application may be a financial services app such as from a bank or fintech organisation. The process starts with a customer performing a transaction at a merchant 991, which may be either in-store or online. The transaction itself is not shown in FIG. 10. Subsequently, the app is running on the customer's phone or tablet. The app includes an integration 993 or widget linking to the applicant. The app has been notified of the transaction. The app integration requests a question from the applicant. The request contains transaction information, which may include transaction data, customer data, and/or merchant data, as well as any the other types of data mentioned previously. The app may be a banking app showing a statement of the customer's account or listing recent transactions. The app integration notifies the customer of the transaction via a notification or presents details of the transaction in the app, such as on a customer's statement. Along with the transaction, the customer is presented with an ability to rate their transaction via the app. The customer provides the rating in the app, such as by single touch. Similarly, to the email implementation the customer may optionally add additional context in a free form text entry box. The app integration sends the rating value and additional context to the device interface after collection. The rating is provided from the app without the use of a web browser.

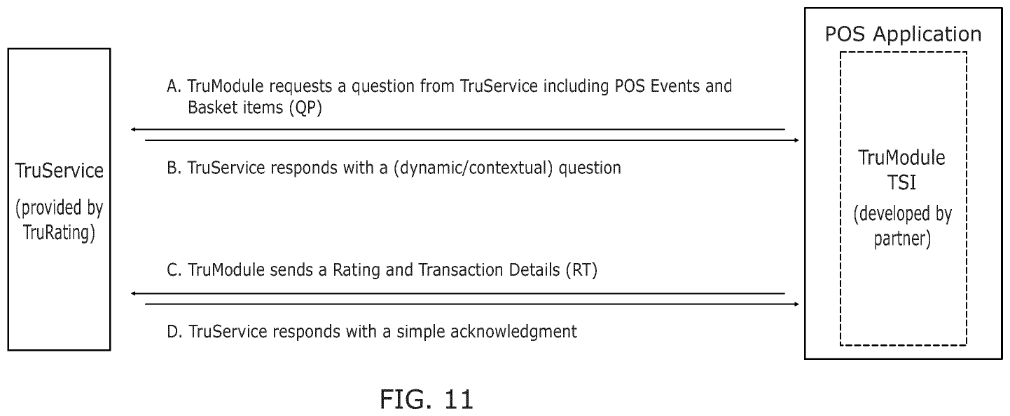

FIG. 11 is a flow-diagram showing the exchange of information between the requesting device and a remote server, which may be the questions server. In the figure the requesting device may be a point-of-sale device running a module configured to provide a ratings or survey facility. The module is labelled as “TruModule” in the figure. At the other end of the exchange of information is a server which may be provided by the applicant, and is labelled as “TruService”. The figure shows a two-legged exchange of information between the POS device and the server. The two-legged exchange is an efficient way of exchanging the information using a minimum number of communications. The first leg of the communications comprises the requesting device (POS Application) sending to a questions server (TruService) data relating to the transaction and a request for a question. The questions server responds by sending the single selected question based on the transaction data received. The first leg (QP) comprises two steps labelled A and B in FIG. 11.

The second leg of the communications follows a customer's response or lack of response and time-out to the single question. The second leg also comprises two-steps. The first step is the requesting device sending to the questions server data relating to the input from the customer in response to the question and, optionally, also sending information relating to the payment of the transaction. The questions server then may optionally send to the requesting device an acknowledgement of receipt of the data from the first step of this second leg. The two steps of the second leg (RT) are labelled C and D in FIG. 11.

The communications are provided over HTTPS (secured by TLS 1.2). The messages are sent in an XML/JSON format in real time over the internet but alternatives formats and communication channels are possible. API communications may be by gRPC.

As further information regarding the two-legged exchange of communications, the initial exchange should take place once the POS device has finished scanning all of the basket items and any discounts and/or loyalty cards are added to the transaction. This is known in the POS industry as a clean (or finalized) basket as all information is known at this point and no further changes will take place before currency is exchanged for the goods or services. At this point (and before payment processing has taken place) the QP (Question+POS/transaction data) exchange takes place. That is, in the scheme of FIG. 9, TruModule, which may be integrated into the POS or a payment application, will perform the QP exchange with TruService. The QP request contains information about the requesting device (for example, the display capabilities in number of characters it can display for the question), the POS Items (for example, the amount, SKU, description, and product category), discounts (for example, the type, percentage, amount, and description) and the customer (for example, the loyalty membership or employee) related to this transaction. After the QP receives its response, usually a question, the TruModule will cause the requesting device to display the question to the customer and await a response. Following this normal payment processing and transaction finalization takes place within the POS or payment application. Following authorization of the payment, at the end of the customer session the RT exchange (Rating and Transaction) takes place with TruService such as at the questions server. The RT data contains information about the rating (for example, how long the customer took to provide the rating, the rating value, and the time of day) and transaction (for example, the tender type, card type, amount, result, currency, entry mode, and a card hash token) related to this transaction.

Core requirements of the rating are that within a transaction a customer is only asked to rate once and that the response to the question is provided by a single key press or touch response. This process may be known as One Arbitrary Question, One Key Response (1AQ1KR) or One Arbitrary Question, One Touch Response (1AQ1TR). The former requirement avoids delays at the point of sale and avoids frustrating the customer, whereas the latter requirement maintains the security of a user's PIN. The single touch or key press response may be either Numeric (0-9), Yes/No, multiple-choice or if the customer does not wish to rate they may press or touch Skip at the CDU. In line with WO 2016/071678 A1 the CDU performs a command that takes some arbitrary text (formatted according to the capabilities and requirements of the device) and waits for just one interactive touch from the user (or times out) before returning the selected value. The implementation of 1AQ1TR may also provide the ability to cancel the rating question to return the device to an idle state on demand.

The rating system may include some services provided in the cloud such as on a cloud-based Software as a service (SaaS) model. This may include the questions server as well as communications delivering the ratings and receiving updates, including new questions and message text. The services in the cloud may be a single point of integration for the ratings and services provided by the system.

The module provided at the POS device (shown as TruModule in FIG. 11) may provide the following functions:
1. Connection to the rating server and other cloud services (TruService);
2. Exchange of data with the POS device and/or CDU applications to control the rating process;
3. Exchange of data between the provider of the ratings service, such as the current applicant, including transaction and POS data elements for ratings & transactions;
4. Perform the rating process at the CDU at the right time;
5. Get an acknowledgment message onto the CDU after the rating and onto the receipt; and
6. Exchange status data with the ratings service provider to maintain the correct activation state.

The POS module (TruModule) is the component of a POS application that connects to the questions server (TruService) in order to provide TruRating services at a point of sale (POS). The POS module (TruModule) is based on API's.

The POS module (TruModule) provides the following:
Support XML over HTTP message connections to the questions server (TruService), including forwarding any POS event messages that may be available from the payment application's POS interface;
Listen for API calls within the POS system and invoke a question in response to a specified question trigger, transaction data, and POS data included within the request (QP);
Connect to the questions server (TruService) to request dynamic question text, acknowledgement text and receipt text in either a single or multiple languages;
Use the POS module to drive the CDU to ask the question (1AQ1TR) and afterwards to display an acknowledgement on the CDU;
Where multiple languages are supported provide a means to either intelligently select the correct language for the customer or provide a mechanism to allow the customer to select or change language;
Capture the rating returned and associate it with details of the transaction details and deliver results to the rating service provider or the ratings database (RT);
Pass any receipt text back to the POS for inclusion on the customer receipt; and
Provide periodic status checking of client's account status.

Communication between the POS module (TruModule) and the questions server (TruService) may require the partner identification number (PID), the merchant identification number (MID) and the terminal identification number (TID) to be exchanged. These three IDs may be used by the questions server to identify the partner, the merchant outlet and to identify the terminal or POS within the outlet. In turn these elements are used by the questions server to ensure that the correct rating questions are asked and that the rating & transactions that are received from the POS module (TruModule) appear correctly on reports to the merchant dashboard and the ratings service provider.

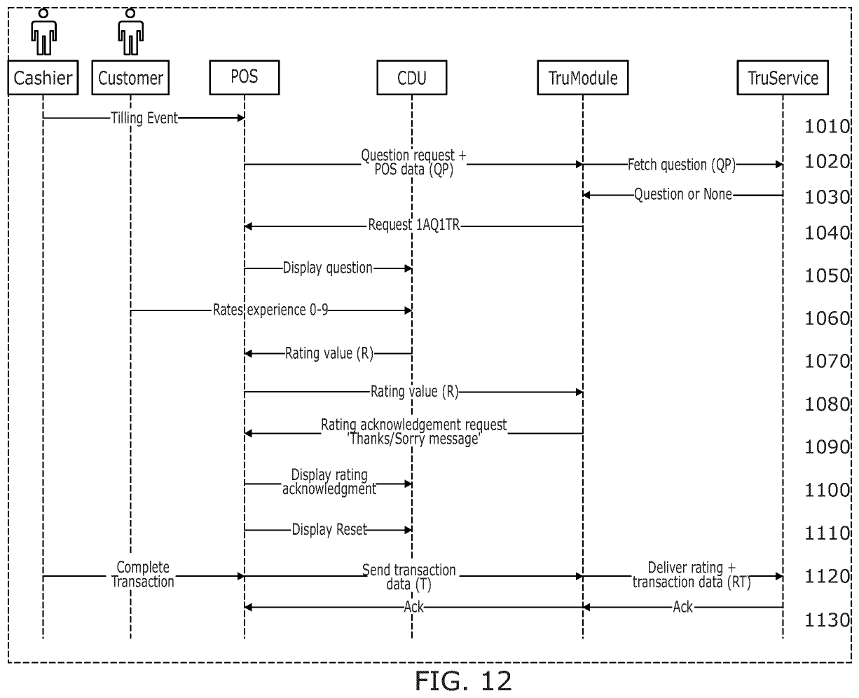

FIG. 12 is UML diagram (Unified Modelling Language) diagram showing the sequence of events and messages for asking questions at an in-store POS device. The diagram includes the cashier and customer at a POS device. The POS device is connected to a Customer Display Unit (CDU) which may be a PIN entry device, PIN on glass or other device for requesting a user to provide payment details and/or PIN. The TruModule is the module at the POS device or a requesting device linked to the POS device which communicates with the questions server, labelled TruService in the figure. The process starts when a customer arrives at a till point and a cashier scans the items in the customers basket. After scanning the cashier provides to the customer a total amount due and the payment process can begin. These steps of scanning and providing the amount due are indicated by “Tilling Event” at step 1010 in FIG. 12. The POS device then, at step 1020, sends a request for a question and transaction data to TruModule, which sends this request on to the questions server (corresponding to the first step of the QP leg of FIG. 11) indicated by TruService in the figure. At step 1030 the questions server responds with a question. If no questions are available for the client, then the questions server sends an indication no questions are available. At step 1040, if a question has been received at TruModule this is passed to the POS device to instruct the CDU to display the question to the customer. If no question is received, the payment transactions continues as normal and no question is asked. At 1050, the question is displayed to the customer on the CDU and at step 1060 the customer provides to the CDU a rating in response to the question. The rating value is sent, at step 1070, from the CDU to the POS device which then, at step 1080 provides the rating to TruModule. Optionally, TruModule itself may provide an acknowledgement such as “Thanks” which at steps 1090 and 1100 is sent to the POS device and displayed on the CDU. At step 1110 the display on the CDU is reset. At step 1120 the cashier completes the transaction and further transaction data and the response to the question are sent to the questions server. The questions server sends an acknowledgement of receipt of this data back to the TruModule which provides the acknowledgement to the POS device. In an alternative to the above-mentioned acknowledgement, having received the acknowledgment at step 1130 the CDU may then display the acknowledgement such as “Thanks for Rating” to the customer.

Although FIG. 12 does not indicate when the payment steps occur it is preferred that the customer is asked to enter their payment card and PIN or, if making a contactless payment to swipe their card at step 1010. The payment authorisation may be received during the steps 1020 to 1130 and is displayed to the customer after the question transaction has completed, such as after step 1130. This approach uses the dead time of waiting for authorization of the payment to ask the question. However, other timings and sequences for the payment and questions steps are possible.

Those skilled in the art will appreciate that variations may be made to the above embodiments without departing from the scope of the invention that is defined by the appended claims.

1. A system operable to collect, from a customer, a response to a question relating to a transaction, the system comprising:
a requesting device configured to send, to a questions server, data relating to the transaction and a request for a question;
the questions server, comprising: a processor; one or more databases storing questions; and a rules engine, the questions server configured to:
receive the data relating to the transaction and the request for a question from the requesting device;
select a question from the stored questions based on the transaction data; and
send the selected question to the requesting device;
wherein the requesting device is further configured to:
present the question to the customer or instruct a display device to present the question to a customer;
wherein the system is further configured to:
receive a response to the question; and
send data related to the response to the questions server or a response database.

2. The system of claim 1, wherein the requesting device is configured to receive the response to the question, and the response is received as an input from the customer at the requesting device.

3. The system of claim 1, wherein the requesting device is configured to receive the response to the question, and the response is provided to the requesting device from the display device or another device.

4. The system of claim 1, wherein the system further comprises a response server configured to receive the response to the question and send data related to the response to the questions server or the response database.

5. The system of claim 1, wherein the step of selecting a question from the stored questions comprises randomly selecting a question from the stored questions relevant to the transaction data.

6. The system of claim 1, wherein the step of selecting a question from the stored questions comprises:
determining, by the rules engine, if any of a first group of questions of the stored questions is triggered based on an element of the transaction data meeting a requirement, and if any one or more of the first group of questions is triggered selecting one of the triggered first group of questions.

7. The system of claim 6, wherein if more than one of the first group of questions are triggered, selecting one of the triggered first group of questions based on a random selection or a weighted random selection.

8. The system of claim 1, wherein the step of selecting a question from the stored questions comprises:
determining, by the rules engine, if any of a first group of questions are applicable to the received transaction data based on an element of the transaction data meeting a requirement; and
from the one or more questions determined from the first group of questions and a second group of questions, selecting a question, wherein the second group of questions are core questions applicable independent of received data, wherein each of the questions has a weighting, and the selection is based on weighted random selection.

9. The system of claim 6, wherein the element of the transaction data meeting a requirement relates at least one of: the customer; a good or service being purchased; the merchant or vendor; the timing of the transaction; the type of transaction; or the payment type.

10. The system of claim 1, wherein the requesting device is configured to send the data relating to the transaction to the questions server, wherein the data relates to one or more of: the customer; a good or service being purchased; the merchant or vendor; the timing of the transaction; the type of transaction; or the payment type.

11. The system of claim 8, wherein the question server is configured to compare the data received from the requesting device with rules from the rules engine to determine if the data matches any triggers set by the rules for applying the first group of questions.

12. The system of claim 8, wherein the weightings of the questions determined from the first group of questions and the second group of questions are normalized with respect to the combined total weightings of the questions determined from the first group of questions and the second group of questions.

13. The system of claim 12, wherein the questions server comprises a random number generator and the random number generator generates a random number to select a single question from the questions determined from the first group of questions and the second group of questions based on the normalized weightings of the questions.

14. The system of claim 1, further comprising customer input and display apparatus arranged in communication with the requesting device, wherein the requesting device is configured to send the selected question to the customer input and display apparatus for display, and the customer input and display apparatus configured to receive an input from the customer in response to the displayed question and to send data related to the input to the requesting device.

15. The system of claim 14, wherein the customer input and display apparatus is a PIN entry device (PED) or a Customer Display Unit (CDU).

16. The system of claim 15, wherein the customer input and display apparatus is configured to receive as an input in response to the question a single key press or touch.

17. The system of claim 1, wherein the requesting device is a server providing a merchant website and the data relating to a transaction is based on a basket of goods selected by a customer on the merchant website.

18. The system of claim 17, wherein the question server being configured to instruct a display device to present a question to a customer and receive an input from a customer, is configured to send the question to the merchant website server for displaying the question on a customer device and receiving input from the customer provided to the merchant website from the customer device.

19. The system of claim 1, wherein after receiving the response to the question, the requesting device proceeds with the payment transaction.

20. The system of claim 19, wherein communications between the requesting device and the questions server comprise one or more of: a Merchant Identification Number (MID), a Terminal Identification Number (TID) and a Partner Identification Number (PID).

21. The system of claim 1, wherein the requesting device collects data relating to the transaction prior to sending the request for a question to the questions server.

22. The system of claim 21, wherein the collection of data relating to the transaction comprises collecting information relating to each of the products being purchased prior to sending the request for a question to the questions server, and the sending of data relating to the transaction to the questions server comprises sending the data as a batch after data relating to all products being purchased has been collected.

23. The system of claim 1, wherein the data relating the transaction comprises information relating to the number of characters that can be displayed on a display device on which the question will be displayed, and the questions server is configured to remove from the questions available for selection any questions that have more than the number of characters that can be displayed on the display.

24. The system of claim 1, wherein the requesting device is configured to receive an input from a customer in response to a question, and the requesting device is configured, if no input is received within a pre-determined time period, to time-out from waiting for a customer input and proceed to request payment authorization.

25. The system of claim 1, wherein the weightings of one or more of the questions available for selection are dynamically adjusted after each instance of receiving an input in response to said one or more questions.

26. The system of claim 1, wherein the system is configured to perform a two-legged exchange of communications between the requesting device and the questions server, wherein
the first leg of the communications comprises the steps of: sending, by the requesting device to a questions server, data relating to the transaction and the request for a question, and sending, by the questions server to the requesting device, the selected question; and
the second leg of the communications comprises the steps of: sending, by the requesting device to the questions server, data relating to the input from the customer in response to the question and data relating to a payment of the transaction, and optionally, sending, by the questions server to the requesting device, an acknowledgement of receipt of the data relating to the input from the customer in response to the questions and data relating to a payment of the transaction.

27. A method of collecting, from a customer, a response to a question relating to a transaction, the method comprising:
sending, by a requesting device, to a questions server, data relating to the transaction and a request for a question;
receiving, at the questions server, the data and the request for a question;
selecting, by the questions server, a question from the stored questions based on the transaction data; and
sending the selected question to the requesting device, wherein the requesting device:
presents the question to the customer or instructs a display device to present the question to a customer;
and wherein the system:
receives a response to the question; and
sends data related to the response to the questions server or a response database.

28. The method of claim 27, wherein the response is received as an input from the customer at the requesting device.

29. The method of claim 27, wherein the requesting device receives the response from the display device or another device.

30. The method of claim 27, wherein the response to the question is received at a response server and the response server sends data related to the response to the questions server or the response database.

31. The method of claim 27, wherein the step of selecting a question from the stored questions comprises randomly selecting a question from the stored questions relevant to the transaction data.

32. The method of claim 27, wherein the step of selecting a question from the stored questions comprises:
determining, by the rules engine, if any of a first group of questions of the stored questions is triggered based on an element of the transaction data meeting a requirement, and if any one or more of the first group of questions is triggered selecting one of the triggered first group of questions.

33. The method of claim 32, wherein if more than one of the first group of questions are triggered, selecting one of the triggered first group of questions based on a random selection or a weighted random selection.

34. The method of claim 27, wherein the step of selecting a question from the stored questions comprises:
determining, by the rules engine, if any of a first group of questions are applicable to the received transaction data based on an element of the transaction data meeting a requirement; and
from the one or more questions determined from the first group of questions and a second group of questions, selecting a question, wherein the second group of questions are core questions applicable independent of received data, wherein each of the questions has a weighting, and the selection is based on weighted random selection.

35. The method of claim 32, wherein the element of the transaction data meeting a requirement relates at least one of: the customer; a good or service being purchased; the merchant or vendor; the timing of the transaction; the type of transaction; or the payment type.

36. The method of claim 27, wherein the requesting device sends the data relating to the transaction to the questions server, wherein the data relates to one or more of: the customer; a good or service being purchased; the merchant or vendor; the timing of the transaction; the type of transaction; or the payment type.

37. The method of claim 27, wherein the method comprises a two-legged exchange of communications between the requesting device and the questions server, wherein
the first leg of the communications comprises the steps of: sending, by the requesting device to a questions server, data relating to the transaction and a request for a question, and sending, by the questions server to the requesting device, the selected question; and
the second leg of the communications comprises the steps of: sending, by the requesting device to the questions server, data relating to the input from the customer in response to the question and data relating to a payment of the transaction, and optionally, sending, by the questions server to the requesting device, an acknowledgement of receipt of the data relating to the input from the customer in response to the questions and data relating to a payment of the transaction.

38. The method of claim 37, wherein the second leg of the communications takes place after the payment transaction has been authorized.

39. The method of claim 37, wherein the first leg of the communications takes place before sending a request for payment authorization.

40. The method of claim 27, wherein the communications are over HTTPS in an XML/JSON format in real-time sent over the Internet.

41. The method of claim 34, wherein the question server compares the data received from the requesting device with rules from the rules engine to determine if the data matches any triggers set by the rules for applying the first group of questions.

42. The method of claim 34, further comprising normalizing the weightings of the questions determined from the first group of questions and the second group of questions with respect to the combined total weightings of the questions determined from the first group of questions and the second group of questions.

43. The method of claim 42, wherein the questions server comprises a random number generator and the random number generator generates a random number to select a single question from the questions determined from the first group of questions and the second group of questions based on the normalized weightings of the questions.

44. The method of claim 27, wherein the requesting device is a server providing a merchant website and the data relating to a transaction is based on a basket of goods selected by a customer on the merchant website.

45. The method of claim 27, wherein after receiving the response to the question, the requesting device proceeds with the payment transaction.

46. The method of claim 27, wherein communications between the requesting device and the questions server comprise one or more of: a Merchant Identification Number (MID), a Terminal Identification Number (TID) and a Partner Identification Number (PID).

47. The method of claim 27, wherein the requesting device collects data relating to the transaction prior to sending the request for a question to the questions server.

48. The method of claim 47, wherein the collection of data relating to the transaction comprises collecting information relating to each of the products being purchased prior to sending the request for a question to the questions server, and the sending of data relating to the transaction to the questions server comprises sending the data as a batch after data relating to all products being purchase has been collected.

49. The method of claim 27, wherein the data relating the transaction comprises information relating to the number of characters that can be displayed on a display device on which the question will be displayed, and the questions server removes from the questions available for selection any questions that have more than the number of characters that can be displayed on the display.

50. The method of claim 27, wherein the requesting device waits to receive an input from a customer in response to a question, and if no input is received within a pre-determined time period, the requesting device times-out from waiting for the customer input and proceeds to request payment authorization.

51. The method of claim 27, further comprising dynamically adjusting the weightings of one or more of the questions of the questions available for selection after each instance of receiving an input in response to said one or more questions.

52. One or more computing devices configured to perform the method of claim 27.

53. A requesting device, comprising a processor and a communications interface, the requesting device configured to:
send, to a questions server, data relating to a transaction and a request for a question;
receive, from the questions server, a selected question;
present the question to the customer or instruct a display device to present the question to a customer;
receive an input from the customer in response to the question;
send data related to the input to the questions server or response database for collation of responses; and
send a request for authorization of a payment to a financial institution.

54. A questions server, the questions server comprising a processor, a communications interface, a database storing a first group of questions and a second group of questions, and a rules engine, the questions server configured to:
receive, from a requesting device, data relating to a transaction and a request for a question;
select a question from the stored questions based on the transaction data; and send the selected question to the requesting device.

55. The questions server of claim 54, further configured to determine, by the rules engine, if any of a first group of questions are applicable to the received data; and
from the one or more questions determined from the first group of questions and a second group of questions, selecting a question, wherein the second group of questions are core questions applicable independent of received data, wherein each of the questions has a weighting, and the selection is based on weighted random selection.

56. The questions server of claim 55, further configured to:
receive data related to the input from the customer; and
send, to the requesting device, an acknowledgement of receipt of the data relating to the input from the customer.
